(19) United States
(12) Patent Application Publication
(10) Pub. No.: US 2011/0140031 A1
(43) Pub. Date: Jun. 16, 2011

(54) Article for Use in Magnetic Heat Exchange, Intermediate Article and Method for Producing an Article for Use in Magnetic Heat Exchange

(75) Inventors: Matthias Katter, Alzenau (DE); Volker Zellmann, Linsengericht (DE)

(73) Assignee: Vacuumschmeize GmbH & Co. KG, Hanau (DE)

(21) Appl. No.: 13/058,838

(22) PCT Filed: Oct. 1, 2008
(86) PCT No.: PCT/IB2008/054006

§ 371 Date: Feb. 11, 2011

(51) Int. Cl. H01F 1/04; H01F 1/00

(52) U.S. Cl. 252/62.55; 252/62.51 R

(57) ABSTRACT

Article for use in magnetic heat exchange, intermediate article and method for producing an article for use in magnetic heat exchange

An article for magnetic heat exchange is produced by heat treating an intermediate article comprising, in total, elements in amounts capable of providing at least one magnetocalorically active LaFe₁₃-based phase and less than 5 Vol % impurities, wherein the intermediate article comprises a permanent magnet. The intermediate article is worked by removing at least one portion of the intermediate article. The intermediate article is then heat treated to produce a final product comprising at least one magnetocalorically active LaFe₁₃-based phase.

### BACKGROUND

1. Field

Disclosed herein is an article for use in magnetic heat exchange and method for producing an article for use in magnetic heat exchange.

2. Description of Related Art

The magnetocaloric effect describes the adiabatic conversion of a magnetically induced entropy change to the evolution or absorption of heat. By applying a magnetic field to a magnetocalorically active material, an entropy change can be induced which results in the evolution or absorption of heat. This effect can be harnessed to provide refrigeration and/or heating.

Magnetic heat exchangers, such as that disclosed in U.S. Pat. No. 6,676,772, typically include a pumped recirculation system, a heat exchange medium such as a fluid coolant, a chamber packed with particles of a magnetic refrigerant working material which displays the magnetocaloric effect and a means for applying a magnetic field to the chamber.

Magnetic heat exchangers are, in principle, more energy efficient than gas compression/expansion cycle systems. They are also considered environmentally friendly as chemicals such as chlorofluorocarbons (CFC) which are thought to contribute to the depletion of ozone levels are not used.

In recent years, materials such as La(Fe₁₋ₐSiₐ)₁₃, (Si,Ge)₄, Mn (As,Sb) and MnFe(P, As) have been developed which have a Curie temperature, T_{c}, at or near room temperature. The Curie temperature translates to the operating temperature of the material in a magnetic heat exchange system. These materials are, therefore, suitable candidates for use in applications such as building climate control, domestic and industrial refrigerators and freezers as well as automotive climate control.

Consequently, magnetic heat exchanger systems are being developed in order to practically realise the advantages provided by the newly developed magnetocalorically active materials. However, further improvements are desirable to enable a more extensive application of magnetic heat exchange technology.

### SUMMARY

There remains a need for an article and methods for producing an article comprising at least one magnetocalorically active phase for use in magnetic heat exchanger in a cost-effective and reliable manner.

In one embodiment is disclosed a method of producing an article comprising at least one magnetocalorically active phase which comprises providing an intermediate article comprising, in total, elements in amounts capable of providing at least one (La₁₋ₐMₐ)(Fe_{1-b-c}T_{b}Y_{c})_{13-d}Xₑ phase and less than 0.5 Vol % impurities, wherein 0≦a≦0.9, 0≦b≦0.2, 0.05≦c≦0.2, −1≦d≦+1, 0≦e≦3, M is one or more of the elements Ce, Pr and Nd, T is one or more of the elements Co, Ni, Mn and Cr, Y is one or more of the elements Si, Al, As, Ga, Ge, Sn and Sb and X is one or more of the elements H, B, C, N, Li and Be. The intermediate article comprises a permanent magnet. The intermediate article is worked by removing at least one portion of the intermediate article, and then heat treated to produce a final product comprising at least one magnetocalorically active (La₁₋ₐMₐ) (Fe_{1-b-c}T_{b}Y_{c})_{13-d}Xₑ phase.

### BRIEF DESCRIPTION OF THE DRAWINGS

Embodiments will be now be explained herein with reference to the drawings.

FIG. 1 is a graph that illustrates the effect of temperature on α-Fe content for an embodiment of a precursor article fabricated by sintering at 1100° C.,

FIG. 2 is a graph that illustrates the effect of temperature on Alpha-Fe content for an embodiment of a precursor article fabricated by sintering at 1080° C.,

FIG. 3 is a graph that illustrates the effect of temperature on Alpha-Fe content for an embodiment of a precursor article fabricated by sintering at 1060° C.,

FIG. 4 is a graph that illustrates a comparison of the results of FIG. 2,

FIG. 5 is a graph that illustrates the effect of temperature on Alpha-Fe content for an embodiment of a precursor article fabricated by sintering at 1080° C.,

FIG. 6 is a graph that illustrates the effect of temperature on Alpha-Fe content for an embodiment of precursor articles of Table 3 having differing compositions,

FIG. 7(a) is an SEM micrograph of an embodiment of a precursor article,

FIG. 7(b) is an SEM micrograph of the embodiment of the precursor article of FIG. 7(a) after heat treatment to produce an embodiment of an intermediate article in a workable condition, and

FIG. 8 is a graph showing a hysteresis loop measured for an embodiment of an intermediate article comprising a composition in total of La(Fe, Si, CO)₁₃.

FIG. 9 is a graph that illustrates temperature dependent change in length observed for an embodiment of an intermediate article and an article comprising a magnetocalorically active phase,

FIG. 10 is a schematic diagram illustrating a method of working an intermediate article according to a first embodiment,

FIG. 11 is a schematic diagram illustrating a method of working an intermediate article according to a second embodiment,

FIG. 12 is a theoretical phase diagram illustrating the silicon content range over which a reversible decomposition of the La(Fe,Si,Co)₁₃ phase may occur.

### DETAILED DESCRIPTION OF SPECIFIC EMBODIMENTS

A permanent magnet is defined herein as an article comprising a coercive field strength of greater than 10 Oe.

This method of producing an article comprising at least one magnetocalorically active phase enables a large block to be fabricated and then further worked to separate the article into two or more smaller articles and/or provide the desired manufacturing tolerances of the outer dimensions in a cost-effective and reliable manner.

Particularly in the case of working articles comprising the magnetocalorically active phase having larger dimensions, for example blocks having dimensions of at least 5 mm or several tens of millimetres, the inventors observed that undesirable cracks were formed in the articles during working, which limited the number of smaller articles with the desired dimensions which could be produced from the large article.

The inventors further observed that this undesirable cracking can be largely avoided by heat treating the article to form an intermediate article which comprises a permanent magnet. The intermediate article has a coercive field strength of greater than 10 Oe according to the definition of permanent magnet used herein.

The intermediate article can be worked without producing undesired cracks, so that the number of individual articles which could be produced from the large article was increased, thus reducing wastage. The intermediate article is then further heat treated to form the magnetocalorically active phase and provide an article suitable for use as the working component of a magnetic heat exchanger.

The method used to fabricate the intermediate article comprising at least one magnetocalorically active phase may be selected as desired. Powder metallurgical methods have the advantage that blocks having large dimensions can be cost effectively produced. Powder metallurgical methods such as milling, pressing and sintering of precursor powders to form a reaction sintered article, or milling of powders comprising at least a portion of one or more magnetocalorically active phases followed by pressing and sintering to form a sintered article, may be used. The intermediate article may also be produced by other methods such as casting, rapid solidification melt spinning and so on and then worked using the method according to the present invention.

A magnetocalorically active material is defined herein as a material which undergoes a change in entropy when it is subjected to a magnetic field. The entropy change may be the result of a change from ferromagnetic to paramagnetic behaviour, for example. The magnetocalorically active material may exhibit, in only a part of a temperature region, an inflection point at which the sign of the second derivative of magnetization with respect to an applied magnetic field changes from positive to negative.

A magnetocalorically passive material is defined herein as a material which exhibits no significant change in entropy when it is subjected to a magnetic field.

A magnetic phase transition temperature is defined herein as a transition from one magnetic state to another. Some magnetocalorically active phases exhibit a transition from antiferromagnetic to ferromagnetic which is associated with an entropy change. Some magnetocalorically active phases exhibit a transition from ferromagnetic to paramagnetic which is associated with an entropy change. For these materials, the magnetic transition temperature can also be called the Curie temperature.

Without being bound by theory, it is thought that the observed cracking of articles comprising the magnetocalorically active phase during working may be caused by a temperature dependent phase change occurring in the magnetocalorically active phase. The phase change may be a change in entropy, a change from ferromagnetic to paramagnetic behaviour or a change in volume or a change in linear thermal expansion.

Performing the working of the article whilst the article is in a non-magnetocalorically active working condition avoids the phase change occurring in the article during working and avoids any tension associated with the phase change occurring during working of the article. Therefore, the article may be worked reliably, the production quota increased and production costs reduced.

In an embodiment, the intermediate article comprises an α-Fe content of greater than 50 vol %. The intermediate article is expected to have an increasingly reduced percentage of the magnetocalorically active phase for increasingly higher Alpha-Fe contents.

In a further embodiment, the intermediate article is heat treated to produce an Alpha-Fe content of less than 5 vol % in the final product.

The intermediate article may be produced by heat treating a precursor article comprising at least one phase with a NaZn₁₃-type crystal structure.

The intermediate article may also be produced by heat treating a precursor article to first form at least one phase NaZn₁₃-type crystal structure and then decompose the NaZn₁₃-type crystal structure and form a permanent magnet by performing a single multi-stage heat treatment.

In an embodiment, the precursor article is heat treated under conditions selected to produce at least one Alpha-Fe-type phase.

The precursor article may be heat treated under conditions selected to produce inclusions of at least one Alpha-Fe-type phase in a non-magnetic matrix.

The precursor article may be heat treated to produce an article comprises at least 60 vol % of at least one Alpha-Fe-type phase.

The precursor article may be produced by mixing powders selected to provide, in total, elements in amounts capable of providing at least one(La₁₋ₐMₐ)(Fe_{1-b-c}T_{b}Y_{c})_{13-d}Xₑ phase and sintering the powders at a temperature T1 to produce at least one phase with a NaZn₁₃-type crystal structure.

After the heat treatment at temperature T1, in certain embodiments the precursor article may be further heat treated at a temperature T2 to form the intermediate article comprising at least one permanently magnetic phase, wherein T2<T1. The heat treatments at T1 and T2 may be carried out without intermediately cooling the article below T2 in one embodiment. The heat treatments may, however, be carried out separately by cooling the precursor article to room temperature after the heat treatment at T1 in another embodiment.

The Alpha-Fe-type phase is formed at a lower temperature than the temperature required to form the phase or phases with the NaZn₁₃-type crystal structure.

If the precursor article comprises at least one phase with a NaZn₁₃-type crystal structure, the temperature T2 may be selected so as to produce a decomposition of the phase with the NaZn₁₃-type crystal structure at T2. The Alpha-Fe-type phase may form as a consequence of the decomposition of the phase with the NaZn₁₃-type crystal structure.

In a further embodiment, the intermediate article is heat treated at a temperature T3 to produce the final product comprising at least one magnetocalorically active (La₁₋ₐMₐ)(Fe_{1-b-c}T_{b}Y_{c})_{13-d}Xₑ phase, wherein T3>T2. In a further embodiment, T3<T1.

In a further embodiment, the composition of the precursor article is selected so as to produce a reversible decomposition of the phase with the NaZn₁₃-type crystal structure at the temperature T2. After decomposition of the phase with the NaZn₁₃-crystal structure at T2, the phase with the NaZn₁₃-type crystal structure may be reformable at a temperature T3, wherein T3 is greater than T2.

The portion of the intermediate article may be removed by any number of methods. For example, the portion of the article may be removed by machining and/or mechanical grinding, mechanical polishing and chemical mechanical polishing and/or electric spark cutting or wire erosion cutting or laser cutting and drilling and water beam cutting. As used herein, removing a portion of the intermediate article including separating the intermediate article into a plurality of smaller articles, as explained below.

A combination of these methods may also be used on a single intermediate article. For example, the intermediate article may be separated into a two or more separate pieces by removing a portion of the intermediate article by wire erosion cutting and then the surfaces subjected to mechanical grinding removing a further portion to provide the desired surface finish. Finally, through-holes may be drilled by laser drilling to provide paths for the heat transfer fluid.

The portion of the intermediate article may also be removed to form a channel in the surface of the intermediate article, for example, a channel for directing the flow of heat exchange medium during operation of the final article in a magnetic heat exchanger. A portion of the intermediate article may also be removed to provide at least one through hole. A through hole may also be used to direct the flow heat exchange medium and to increase the effective surface area of the final article so as to improve thermal transfer between the article and the heat exchange medium.

An intermediate article for the production of an article comprising at least one magnetocalorically active phase is also provided which comprises, in total, elements in amounts capable of providing at least one (La₁₋ₐMₐ)(Fe_{1-b-c}T_{b}Y_{c})_{13-d}Xₑ phase and less than 5 Vol % impurities, wherein 0≦a≦0.9, 0≦b≦0.2, 0.05≦c≦0.2, −1≦d≦+1, 0≦e≦3, M is one or more of the elements Ce, Pr and Nd, T is one or more of the elements Co, Ni, Mn and Cr, Y is one or more of the elements Si, Al, As, Ga, Ge, Sn and Sb and X is one or more of the elements H, B, C, N, Li and Be. The intermediate article comprises a permanent magnet.

This intermediate article can be easily worked by machining, for example, grinding and wire erosion cutting. Therefore, a large block may be produced, by cost effective methods such as powder metallurgical techniques, and then further worked to provide a number of smaller articles having the desired dimensions for a particular application. The working may be carried out by separately from the production of the block.

For example, the customer can purchase the intermediate block, work the intermediate block to provide the number and shape or articles he desires. Afterwards, the customer can heat treat these worked articles to form the magnetocalorically active phase or phases.

Alternatively, the production of the intermediate article and heat treatment of the worked articles may be carried out by a first establishment equipped with appropriate facilities. The working may be carried out by a second different establishment equipped with suitable working facilities but no appropriate heat treatment facilities.

Articles comprising at least one magnetocalorically active phase for use in magnetic heat exchangers can be cost-effectively produced for a wide variety of applications from the intermediate product.

In an embodiment, the composition of the at least one (La₁₋ₐMₐ)(Fe_{1-b-c}T_{b}Y_{c})_{13-d}Xₑ phase is selected so as to exhibit a reversible phase decomposition reaction. This enables the La₁₋ₐMₐ)(Fe_{1-b-c}T_{b}Y_{c})_{13-d}Xₑ phase to be formed in a first step, decomposed to provide the intermediate product and then afterwards reformed in a further heat treatment once working is complete.

The composition of the at least one (La₁₋ₐMₐ) (Fe_{1-b-c}T_{b}Y_{c})_{13-d}Xₑ phase may be selected so as to exhibit a reversible phase decomposition reaction into at least one α-Fe-based phase and La-rich and Si-rich phases.

In a further embodiment, the composition of the at least one (La₁₋ₐMₐ)(Fe_{1-b-c}T_{b}Y_{c})_{13-d}Xₑ phase is selected so that the at least one (La₁₋ₐMₐ)(Fe_{1-b-c}T_{b}Y_{c})_{13-d}Xₑ phase is formable by liquid-phase sintering. This enables an article with a high density to be produced and also an article with a high density to be produced in an acceptable time.

In an embodiment, the intermediate article comprises a composition, in total, in which a=0, T is Co and Y is Si and e=0 and in a further embodiment 0<b≦0.075 and 0.05<c≦0.1 when a=0, T is Co and Y is Si and e=0.

The intermediate article may comprise at least one Alpha-Fe-type phase. In a further embodiment, the intermediate article comprises greater than 60 vol % of one or more Alpha-Fe-type phases. The Alpha-Fe-type phase may further comprise Co and Si.

In an embodiment, the intermediate article further comprises La-rich and Si-rich phases.

In further embodiments, the intermediate article comprises the following magnetic properties: Bᵣ>0.35T and H_{cJ}>80 Oe and/or Bₛ>1.0 T.

The intermediate article may comprise a composite structure comprising a non-magnetic matrix and a plurality of Alpha-Fe-inclusions distributed in the non-magnetic matrix. As used herein, non-magnetic refers to the condition of the matrix at room temperature and includes paramagnetic and diamagnetic materials as well as ferromagnetic materials with a very small saturation polarization.

The intermediate article may have a coercive field strength of greater than 10 Oe but less than 600 Oe. Articles with such a coercive field strength are sometimes called half hard magnets.

The permanent magnetic inclusions may comprise an Alpha-Fe-type phase.

In a further embodiment, the intermediate article exhibits a temperature dependent transition in length or volume at the working temperature wherein (L_{10%}-L_{90%})×100/L<0.1, wherein L is the length of the article at temperatures below the transition, L_{10%} is the length of the article at 10% of the maximum length change and L_{90%} at 90% of the maximum length change. The working temperature may be room temperature. The intermediate article comprises a small temperature dependent transition in length or volume at the working temperature so that cracking due to stress caused by changes in length or volume can be avoided.

An article comprising at least one magnetocalorically active LaFe₁₃-based phase having a magnetic phase transition T_{c} and less than 5 Vol % impurities is also provided. The composition of the at least one LaFe₁₃-based phase is selected so as to exhibit a reversible phase decomposition reaction.

The composition of the at least one LaFe₁₃-based phase comprises Si and may be selected so as to exhibit a reversible phase decomposition reaction into at least one Alpha-Fe-based phase and La-rich and Si-rich phases.

In a further embodiment, the silicon content is selected so that at least one LaFe₁₃-based phase exhibits a reversible phase decomposition reaction into at least one α-Fe-based phase and La-rich and Si-rich phases.

In a further embodiment, the composition of the at least one LaFe₁₃-based phase is selected so that the at least one LaFe₁₃-based phase is formable by liquid-phase sintering.

In a further embodiment, the LaFe₁₃-based phase is a (La₁₋ₐMₐ)(Fe_{1-b-c}T_{b}Y_{c})_{13-d}Xₑ-based phase, wherein 0≦a≦0.9, 0≦b≦0.2, 0.05≦c≦0.2, −1≦d≦+1, 0≦e≦3, M is one or more of the elements Ce, Pr and Nd, T is one or more of the elements Co, Ni, Mn and Cr, Y is one or more of the elements Si, Al, As, Ga, Ge, Sn and Sb and X is one or more of the elements H, B, C, N, Li and Be.

In a further embodiment, a=0, T is Co and Y is Si and e=0 and/or 0<b≦0.075 and 0.05<c≦0.1.

In a further embodiment, the article comprises a magnetocalorically active phase which exhibits a temperature dependent transition in length or volume. The transition may occur over a temperature range which is larger than the temperature range over which a measurable entropy change occurs.

The transition may be characterized by (L₁₀%-L_{90%})×100/L>0.2, wherein L is the length of the article at temperatures below the transition, L_{10%} is the length of the article at 10% of the maximum length change and L_{90%} at 90% of the maximum length change. This region characterizes the most rapid change in length per unit of temperature T.

In an embodiment, the magnetocalorically active phase exhibits a negative linear thermal expansion for increasing temperatures. This behaviour may be exhibited by a magnetocalorically active phase comprising a NaZn₁₃-type structure for example, a (La₁₋ₐMₐ)(Fe_{1-b-c}T_{b}Y_{c})_{13-d}Xₑ-based phase.

In a further embodiment, the magnetocalorically active phase of the article consists essentially of, or consists of, this (La₁₋ₐMₐ)(Fe_{1-b-c}T_{b}Y_{c})_{13-d}Xₑ-based phase.

In further embodiments, the article comprises at least two or a plurality of magnetocalorically active phases, each having a different magnetic phase transition temperature T_{c}.

The two or more magnetocalorically active phases may be randomly distributed throughout the article. Alternatively, the article may comprise a layered structure, each layer consisting of a magnetocalorically active phase having a magnetic phase transition temperature which is different from the magnetic phase transition temperature of the other layers.

In particular, the article may have a layered structure with a plurality of magnetocalorically active phases having magnetic phase transition temperatures such that the magnetic phase transition temperature increases along a direction of the article and, therefore, decreases in the opposing direction of the article. Such an arrangement enables the operating temperature of the magnetic heat exchanger in which the article is used to be increased.

An article comprising at least one magnetocalorically active phase having a magnetic phase transition temperature T_{c} is also provided which is manufactured using the method of one of embodiments described above. This article may be used for magnetic heat exchange, for example as the working component of a magnetic heat exchanger.

An article comprising at least one magnetocalorically active phase may be produced by producing a precursor article comprising at least one magnetocalorically active phase and heat treating the precursor article to form an intermediate article having permanent magnetic properties which can be worked. The intermediate article is worked by removing one or more portions and then heat treated to form at least one magnetocalorically active phase.

Formation of Intermediate Workable Articles

For a La(Fe,Si,Co)₁₃ phase, it has been found that the presence or absence of the magnetocalorically active phase and therefore the workable condition of the article can be estimated by measuring the Alpha-Fe content. The intermediate workable condition is characterized by a high Alpha-Fe content.

The nomenclature La(Si, Fe, Co)₁₃ is used to indicate that the sum of the elements Si, Fe and Co is 13 for 1 La. The Si, Fe and Co content may, however, vary although the total of the three elements remains the same.

In a first set of experiments, the heat treatment conditions which lead to the formation of a high Alpha-Fe content in samples comprising a magnetocalorically active La(Fe,Si,Co)₁₃ phase or, in total, elements in amounts capable of producing a magnetocalorically active La(Fe,Si,Co)₁₃ phase were investigated.

The Alpha-Fe content was measured using a thermomagnetic method in which the magnetic polarization of a sample heated above its Curie Temperature is measured as the function of temperature of the sample when it is placed in an external magnetic field. The Curie temperature of a mixture of several ferromagnetic phases can be determined and the proportion of Alpha-Fe determined by use of the Curie-Weiss law.

In particular, thermally insulated samples of around 20 g are heated to a temperature of around 400° C. and placed in a Helmholz-coil which is situated in an external magnetic field of around 5.2 kOe produced by a permanent magnet. The induced magnetic flux is measured as a function of temperature as the sample cools.

### Embodiment 1

A powder mixture comprising 18.55 wt % lanthanum, 3.6 wt % silicon, 4.62 wt % cobalt, balance iron was milled under protective gas to produce an average particle size of 3.5 μm (F. S. S. S.). The powder mixture was pressed under pressure of 4 t/cm² to form a block and sintered at 1080° C. for 8 hours. The sintered block had a density of 7.24 g/cm³. The block was then heated at 1100° C. for 4 hours and 1050° C. for 4 hours and rapidly cooled at 50K/min to provide a precursor article. The precursor article comprised around 4.7% of Alpha-Fe phases.

The precursor article was then heated for a total of 32 hours at temperatures from 1000° C. to 650° C. in 50° C. steps, whereby the dwell time at each temperature was 4 hours to produce a magnetic article with permanent magnetic properties. After this heat treatment, the block comprised 67.2 percent of Alpha-Fe phases.

The magnetic properties of the block were measured. The coercive field strength H_{cJ} of the block was 81 Oe, the remanence 0.39 T and the saturation magnetization was 1.2 T.

### Embodiment 2

A powder mixture comprising 18.39 wt % lanthanum, 3.42 wt % silicon, 7.65 wt % cobalt, balance iron was milled under protective gas, pressed to form a block and sintered at 1080° C. for 4 hours to produce a precursor article.

The precursor article was then heated at 750° C. for 16 hours to produce a permanent magnet. After this heat treatment, the precursor article was observed to have an Alpha-Fe content of greater than 70%.

A second precursor article produced from this powder batch was heated at a temperature of 650° C. A dwell time of 80 hours at 650° C. produced an Alpha-Fe content of greater than 70%.

### Embodiment 3

A powder mixture comprising 18.29 wt % lanthanum, 3.29 wt % silicon, 9.68 wt % cobalt, balance iron was milled under protective gas, pressed to form a block and sintered at 1080° C. for 4 hours to produce a precursor article.

The precursor article was then heated at 750° C. A dwell time of 80 hours was required to produce an Alpha-Fe content of greater than 70%.

From a comparison of embodiments 2 and 3, the temperature and dwell time required to produce a magnetic article with an Alpha-Fe content of greater than 70% is observed to depend on the total composition of the precursor article.

A magnetic article may be expected to have increasingly better machining properties for increasing Alpha-Fe contents. The effect of the heat treatment conditions on the measured Alpha-Fe content was investigated further in the following embodiments.

Effect of Heat Treatment Temperature on α-Fe Content

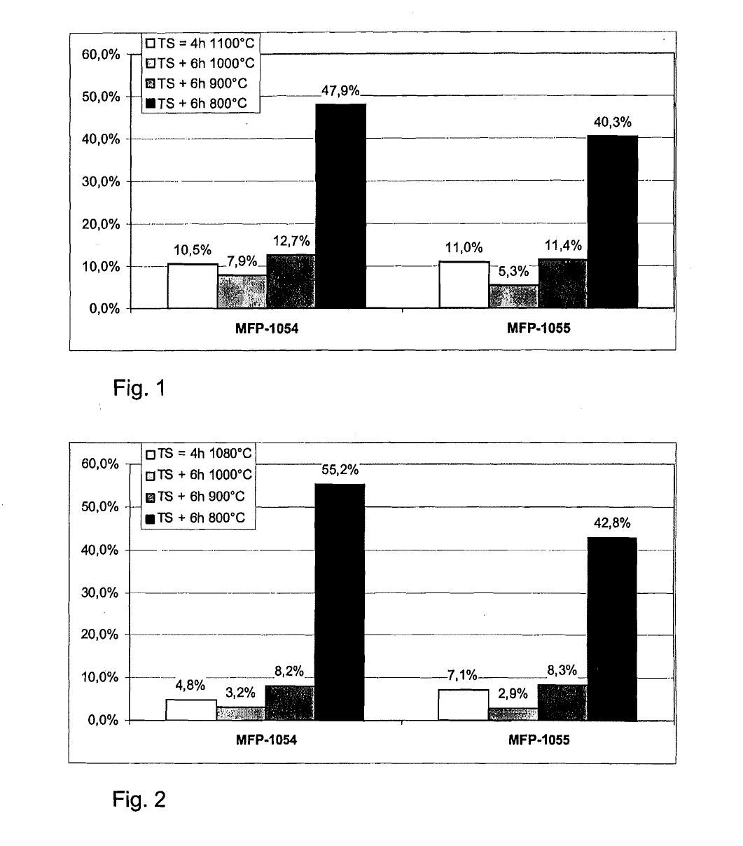

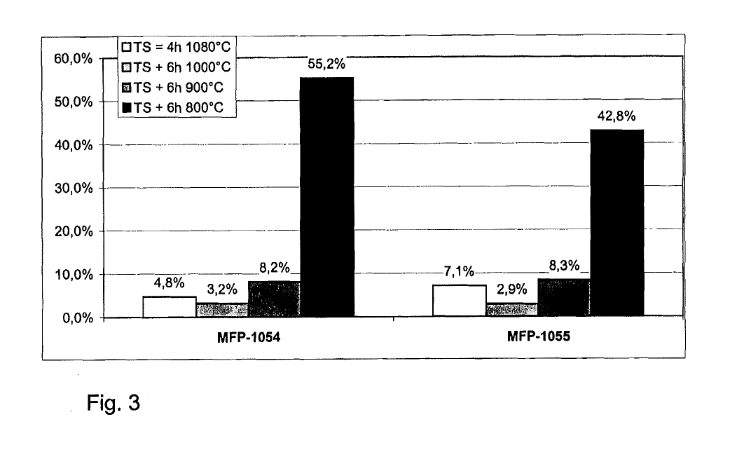

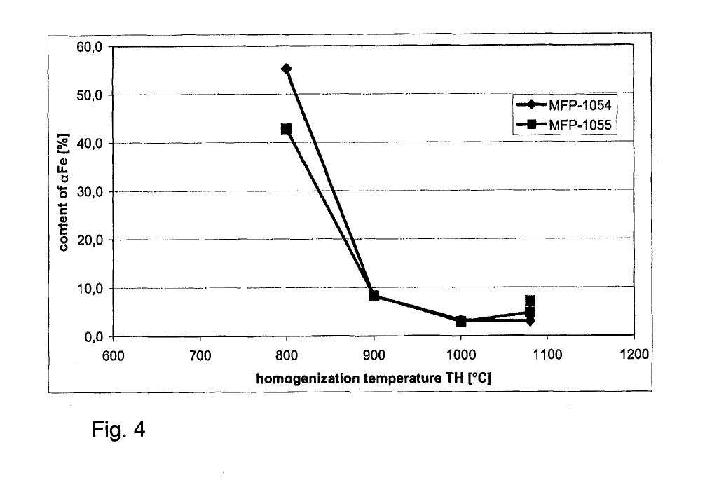

The effect of temperature on Alpha-Fe content was investigated for precursor articles fabricated using the powder mixture of embodiments 2 and 3 above. The results are summarized in FIGS. 1 to 5.

Powder mixtures of embodiments 2 and 3 were pressed to form blocks and sintered at three different temperatures 1100° C., 1080° C. and 1060° for 4 hours, the first 3 hours in vacuum and the fourth hour in argon to produce precursor articles.

A precursor article of each composition sintered at each of the three temperatures was then heated for 6 hours in argon at 1000° C., 900° C. or 800° C. and the Alpha-Fe content measured. The results are summarised in FIGS. 1 to 3.

The Alpha-Fe content was measured to be much larger after a heat treatment at a temperature of 800° C. for both compositions for all of the samples than after a heat treatment at 900° C. or 1000° C.

FIG. 4 illustrates a comparison of the two samples of FIG. 2 and indicates that for a given temperature, the Alpha-Fe content obtained may depend at least in part on the composition of the sample.

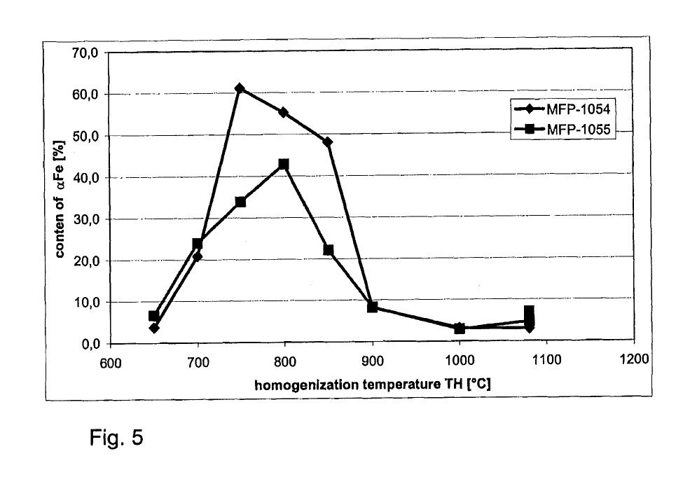

FIG. 5 illustrates a graph of Alpha-Fe content measured for pre-sintered precursor articles having a composition corresponding to that of embodiments 2 and 3 and heat treated at temperatures in the range 650° C. to 1080° C. to produce an intermediate article having permanent magnetic properties.

The results of these experiments indicate that, for a particular dwell time, in this embodiment 4.hours, there is an optimum temperature range for producing a high Alpha-Fe content as the graph for each sample has a peak.

For a heat treatment time of four hours, the maximum Alpha-Fe was observed at 750° C. for embodiment 2 and the maximum Alpha-Fe observed at 800° C. for embodiment 3. These results also indicate that the optimum heat treatment conditions to produce the highest Alpha-Fe content depends on the composition of the precursor article.

Effect of the Heat Treatment Time on α-Fe Content

In a further set of experiments, the effect of the heat treatment time on the Alpha-Fe content was investigated.

Sintered precursor articles comprising the composition of Embodiments 2 and 3 were heat treated at 650° C., 700° C., 750° C. and 850° C. for different times and the Alpha-Fe content measured.

The results are summarised in Tables 1 and 2.

TABLE 1
α-Fe content for intermediate articles fabricated from
precursor articles having the composition of embodiment 2.

| Temperature | α-Fe content (%) measured after a dwell time of | | | |
|---|---|---|---|---|
| (° C.) | 4 hours | 16 hours | 64 hours | 88 hours |
| 850 | 48.1 | 66.1 | 65.4 | |
| 750 | 61.1 | 73.1 | 75.6 | |
| 700 | 20.8 | 71.5 | 78.3 | |
| 650 | 3.7 | 7.8 | | 74.6 |

TABLE 2
α-Fe content for intermediate articles fabricated from
precursor articles having the composition of embodiment 3.

| Temperature | α-Fe content (%) measured after a dwell time of | | | |
|---|---|---|---|---|
| (° C.) | 4 hours | 16 hours | 64 hours | 88 hours |
| 850 | 22.1 | 53.1 | 60.9 | |
| 750 | 33.9 | 59.4 | 70.0 | |
| 700 | 24.0 | 50.6 | 68.5 | |
| 650 | 6.6 | 17.2 | | 63.4 |

These results indicate that, in general, the Alpha-Fe content increases for increased heat treatment times at these temperatures.

Effect of Cooling Rate on Alpha-Fe Content

The effect of a slow cooling rate was simulated for a second set of precursor articles sintered to produce a magnetocalorically active phase having a Curie temperature and composition as listed in Table 3.

TABLE 3
Curie temperature T_{c} and composition of precursor articles used
to investigate the effect of cooling rate on Alpha-Fe content.

| Sample | | | | | |
|---|---|---|---|---|---|
| No. | T_{c} (° C.) | Laₘ (%) | Siₘ (%) | Coₘ (%) | Feₘ (%) |
| MPS1037 | −16 | 16.70 | 3.72 | 4.59 | balance |
| MPS1038 | −7 | 16.69 | 3.68 | 5.25 | balance |
| MPS1039 | +3 | 16.67 | 3.64 | 5.99 | balance |
| MPS1040 | +15 | 16.66 | 3.60 | 6.88 | balance |
| MPS1041 | +29 | 16.64 | 3.54 | 7.92 | balance |
| MPS1042 | +44 | 16.62 | 3.48 | 9.03 | balance |
| MPS1043 | +59 | 16.60 | 3.42 | 10.14 | balance |

The compositions listed in Table 3 are the so called metallic contents of the precursor articles and are therefore denoted with the subscript m. The metallic content of an element differs from the overall content of the element in that the portion of the element which is present in the article in the form of an oxide or nitride, for example La₂O₃ and LaN, is subtracted from the overall content. Finally, this corrected content is related to the sum of all metallic constituents to give the metallic content.

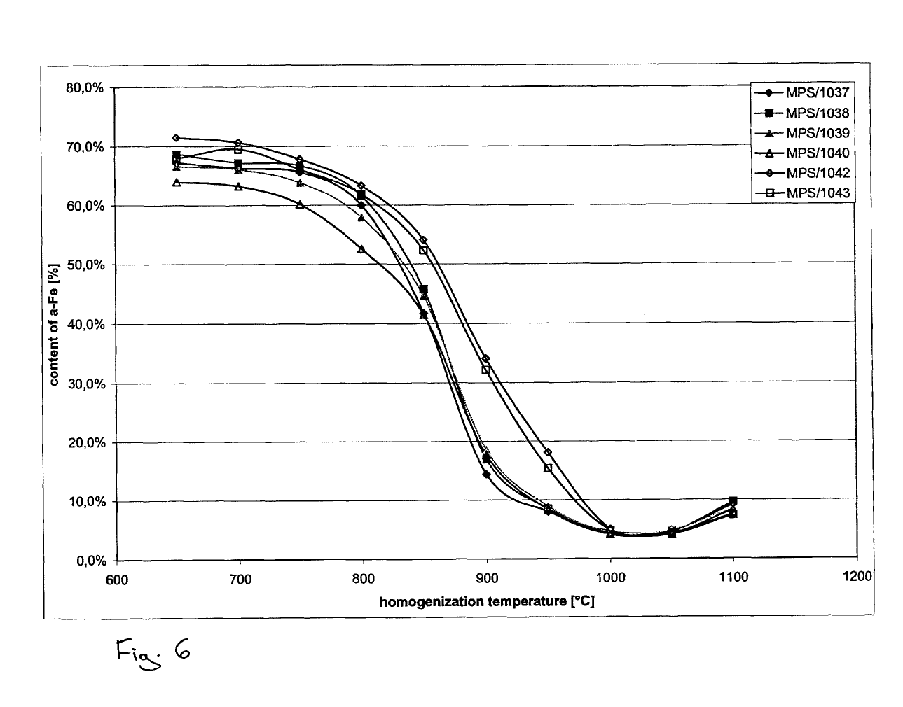

A very slow cooling rate was simulated by heating the samples at 1100 for 4 hours followed by rapid cooling to determine a starting Alpha-Fe content. Afterwards the temperature was reduced at 50° C. intervals and the sample heated for further 4 hours at each temperature before being rapidly cooled. The Alpha-Fe content was measured after heat treatment at each temperature. The results are illustrated in FIG. 6 and summarised in Table 4.

TABLE 4
α-Fe content measured after a heat treatment at different temperatures
for 4 hours, each sample having previously undergone heat treatment
at all the higher temperatures above it in the table.

| Temperature | Sample No. | | | | | |
|---|---|---|---|---|---|---|
| (° C.) | MPS1037 | MPS1038 | MPS1039 | MPS1040 | MPS1042 | MPS1043 |
| Starting | 11.2% | 13.2% | 14.9% | 12.2% | 18.4% | 15.9% |
| condition | | | | | | |
| 1100 | 9.3% | 9.6% | 8.5% | 8.3% | 7.5% | 7.4% |
| 1050 | 4.7% | 4.6% | 4.8% | 4.2% | 4.4% | 4.2% |
| 1000 | 4.6% | 4.4% | 4.5% | 4.1% | 5.1% | 4.8% |
| 950 | 8.0% | 8.5% | 8.9% | 8.3% | 18.1% | 15.4% |
| 900 | 14.3% | 16.9% | 18.5% | 17.7% | 34.0% | 32.1% |
| 850 | 41.7% | 45.7% | 44.6% | 41.4% | 54.1% | 52.3% |
| 800 | 60.0% | 61.6% | 57.9% | 52.5% | 63.3% | 61.8% |
| 750 | 65.6% | 66.7% | 63.8% | 60.2% | 67.8% | 66.1% |
| 700 | 66.3% | 67.2% | 66.1% | 63.2% | 70.6% | 69.5% |
| 650 | 67.2% | 68.7% | 66.6% | 64.0% | 71.5% | 67.9% |

The Alpha-Fe content was observed to increase for decreasing temperature for all of the samples. In contrast to the embodiment illustrated in FIG. 5, the samples with the higher cobalt content have a larger Alpha-Fe content than those with lower cobalt contents.

Microstructure and Phase Distribution of a Precursor Article and an Intermediate Article

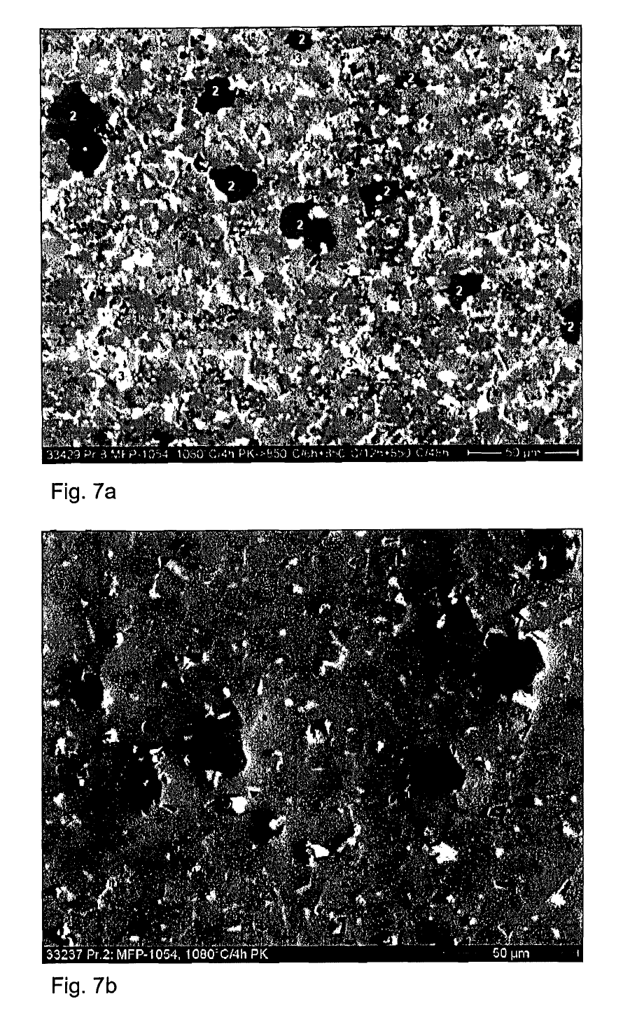

FIG. 7a illustrates a SEM micrograph of a precursor article having a composition of 3.5 wt % silicon and 8 wt % cobalt which was sintered at 1080° C. for 4 hours. This precursor article includes a La(FeSiCo)₁₃-based phase which is magnetocalorically active.

FIG. 7b illustrates an SEM micrograph of the block of FIG. 7a after it has undergone a heat treatment at 850° C. for a total of 66 hours. The block comprises a number of phases characterised by areas having a different degree of contrast in the micrograph. The light areas were measured by EDX analysis to be La-rich and the small dark areas Fe-rich.

Magnetic Properties of an Intermediate Article

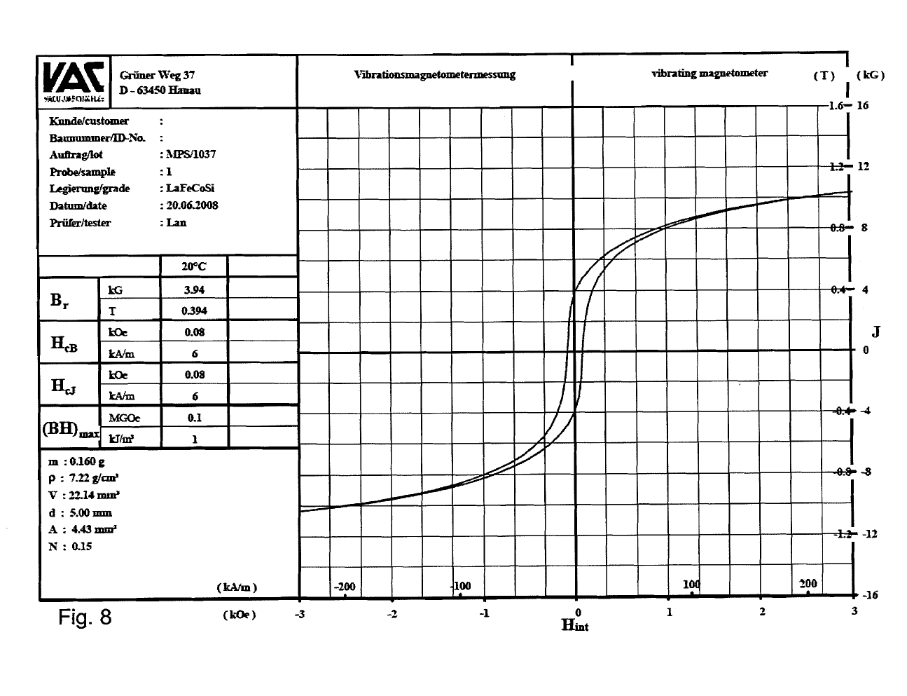

FIG. 8 illustrates a hysteresis loop of an intermediate article having an overall composition of La(Fe, Si, Co)₁₃ with 4.4 wt % cobalt which was slowly cooled from a temperature of 1100° C. to 650° C. in 40 hours and measured to have an Alpha-Fe content of 67%. The magnetic properties measured are summarised in Table 5. The sample has a Bᵣ of 0.394T, H_{cB} of 0.08 kOe, H_{cJ} of 0.08 kOe and (BH)ₘₐₓ of 1 kJ/m³.

TABLE 5
Magnetic properties measured at 20°
C. for the intermediate article of FIG. 8.

| | | |
|---|---|---|
| Bᵣ | 0.394 | T |
| H_{cB} | 6 | kA/m |
| H_{cJ} | 6 | kA/m |
| (BH)ₘₐₓ | 1 | kJ/m³ |

Linear Thermal Expansion of an Intermediate Article and a Final Article

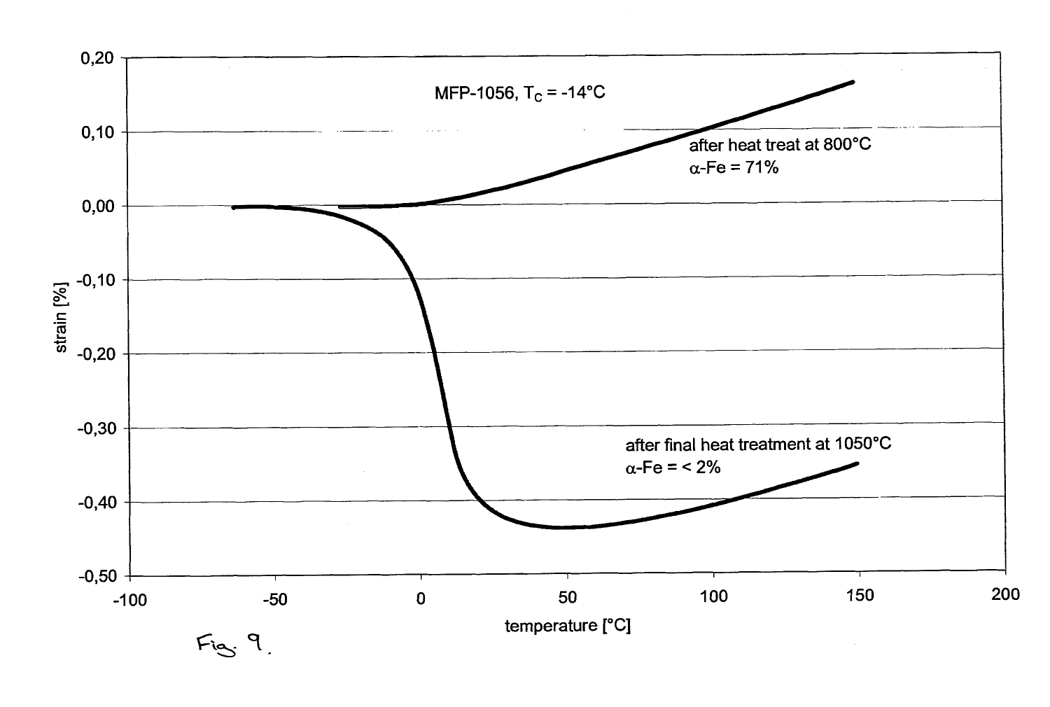

FIG. 9 illustrates the thermal expansion for temperatures in the range of −50° C. to +150° C. for an article having an overall composition of La(Fe, Si, Co)₁₃ with 4.4 wt % cobalt and heated treated to be in the workable state and in the magnetocalorically active state.

An article sintered at 1100° C. for a total of 4 hours, the first 3 hours being carried out under vacuum and the final hour under argon was heated at 800° C. for 4 hours under Argon to provide an intermediate article in the workable state. The intermediate article has an Alpha-Fe content of 71% and shows a positive, generally linear, change in length for increasing temperatures above around 0° C.

The intermediate article was given a further heat treatment at a higher temperature of 1050° C. for 6 hours to provide a final article having an Alpha-Fe content of less than 2% and comprising a magnetocalorically active La(Fe, Si, Co)₁₃-based phase. The final article shows a negative change in length of −0.44% for increasing temperatures in the range from around −50° C. to around +40° C.

In the workable condition, the article does not display a large change in length, in particular, a large negative change in length for temperatures in the region of its Curie temperature.

Without being bound by theory, it is thought that during working of a final article, heat generated by the working process causes the article to be heated over the temperature range in which a large change in length is observed. This change in length of the article is thought to be responsible for the cracks observed during working of articles comprising a magnetocalorically active phase. By decomposing the magnetocalorically active phase, an article is provided which displays a different thermal expansion behaviour, in this embodiment, a slight positive increase in the length. Heat generated in the article whilst it is in the workable condition fails to produce a change in length which is significantly large to result in cracking of the article.

Mechanical Properties of an Intermediate Article and a Final Article

The compression strength of articles in the workable condition and in the final produce condition was also measured.

An article with 4.4 wt % Co was found to have an average compression strength of 1176.2 N/mm² and an elastic modulus of 168 kN/mm² in the workable condition and an average compression strength of 657.6 N/mm² and an elastic modulus of 155 kN/mm² in the final product condition.

An article with 9.6 wt % Co was found to have an average compression strength of 1123.9 N/mm² and an elastic modulus of 163 kN/mm² in the workable condition and an average compression strength of 802.7 N/mm² and an elastic modulus of 166 kN/mm² in the final product condition.

The intermediate article could be worked by grinding and wire erosion cutting to produce two or more smaller intermediate articles from the as-produced larger intermediate article.

Working of Intermediate Articles

In an embodiment, an intermediate article having a composition of 18.55 wt % La, 4.64 wt % Co, 3.60 wt % Si, balance iron and dimensions of 23 mm×19 mm×6.5 mm was singulated by wire erosion cutting into a plurality of pieces having dimensions of 11.5 mm×5.8 mm×0.6 mm.

In a further embodiment, an intermediate article having a composition of 18.72 wt % La, 9.62 wt % Co, 3.27 wt % Si, balance iron and dimensions of 23 mm×19 mm×6.5 mm was singulated by wire erosion cutting into a plurality of pieces having dimensions of 11.5 mm×5.8 mm×0.6 mm.

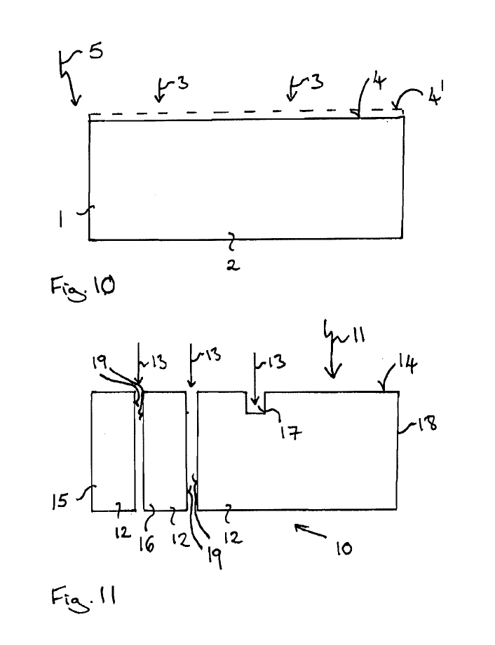

FIG. 10 illustrates a method of working an intermediate article 1 comprising a magnetocalorically active phase 2. The magnetocalorically phase 2 is a La(Fe_{1-a-b}CoₐSi_{b})₁₃-based phase and has a magnetic phase transition temperature T_{c} of 44° C. For this phase, the magnetic phase transition temperature may also be described as the Curie temperature as the phase under-goes a transition from ferromagnetic to paramagnetic.

In this embodiment, the intermediate article 1 is fabricated by powder metallurgical techniques. In particular, a powder mixture with an appropriate overall composition is compressed and reactively sintered to form the intermediate article 1. However, the method of working according to the present application may also be used for articles comprising one or more magnetocalorically active phases produced by other methods such as casting or sintering of precursor powders consisting essentially of the magnetocalorically active phase itself.

A precursor article was heat treated at a first temperature T1 selected to enable liquid-phase sintering of the La(Fe_{1-a-b}CoₐSi_{b})₁₃-based phase to occur. The precursor article was further heat treated at a temperature T2, whereby T2<T1 to provide an intermediate article 1 comprising less than 5% of magnetocalorically active material which can be reliably worked by machining methods such as wire erosion cutting in which at least one portion of the intermediate article is removed. The intermediate article 1 is also characterized by a positive linear change in length and an Alpha-Fe content of at least 50%.

In the first embodiment, the intermediate article 1 is worked by mechanical grinding, indicated schematically in FIG. 1 by the arrows 3. In particular, FIG. 1 illustrates the mechanical grinding of an outer surface 4 of the article 1. The position of the outer surface 4 of the article 1 in the as-produced state is indicated by the dashed line 4′ and the position of the outer surface 4 after working is indicated by the solid line. The surface 4 has a contour and roughness typical of a ground surface.

The working of the intermediate article 1 by grinding of the outside surfaces may be carried out to improve the surface finish and/or improve the dimensional tolerance of the article 1. Polishing may also be used to produce a finer surface finish.

After the intermediate article is worked, it is subjected to a further heat treatment to form the final article at a temperature T3, where T3>T2 and T3<T1 to form at least one magnetocalorically active La(Fe_{1-a-b}CoₐSi_{b})₁₃-based phase.

It has been observed that the final article 1 may contain cracks when it is removed from the furnace after the final heat treatment. Crack formation was observed to be greater in larger articles, for example articles having a dimension of greater than 5 mm. It was observed that, if the cooling rate over the temperature region of the Curie temperature is reduced, crack formation in the article 1 can be avoided.

Similarly, when heating up articles comprising a magnetocalorically active phase, it was observed that crack formation in articles having dimensions greater than around 5 mm could be avoided by reducing the ramp rate in a temperature region extending to either side of the Curie temperature of the article.

In a further embodiment, after sintering, the intermediate article was cooled within one hour from about 1050° C. to 60° C. which is slightly above the Curie Temperature of the magnetocalorically active phase of 44° C. Then the intermediate article 1 was slowly cooled from 60° C. to 30° C.

Without being bound by theory, it is thought that this crack formation during cooling of the intermediate article 1 to room temperature after reactive sintering is associated with the negative thermal expansion of the magnetocalorically active phase as the article 1 passes through its Curie temperature 44° C. By reducing the cooling rate as the magnetocalorically active phase passes its Curie temperature, cracks can be avoided due to the reduction of stress within the article 1.

FIG. 11 illustrates a second embodiment, in which an intermediate article is singulated into two or more separate pieces, one or more through-holes may be formed which extend from one side to another of the article or a channel may be formed in a surface of the article. The through-hole and channel may be adapted to direct cooling fluid when the article is in operation in a magnetic heat exchanger.

Wire erosion cutting may be used to singulate the intermediate article 10 to form one or more separate portions, in this embodiment, slices 15, 16 as well as to form one or more channels 17 in one or more faces 18, of the intermediate article 10.

The side faces 19 of the slices 15, 16 as well as the faces forming the channel 17 have a wire-erosion cut surface finish. These surfaces comprise a plurality of ridges extending in directions parallel to the direction in which the wire cut through the material.

The channel 17 may have dimensions and be arranged in the face 18 so as to direct the flow of a heat exchange fluid during operation of a magnetic heat exchanger in which the article may also comprise magnetocalorically passive phases. The magnetocalorically passive phases may be provided in the form of a coating of the grains of the magnetocalorically active phase which acts as a protective coating and/or corrosion resistant coating, for example.

A combination of different working methods may be used to manufacture a final product from the as-produced article. For example, the as-produced article could be ground on its outer surfaces to produce outer dimensions with a tight manufacturing tolerance. Channels may then be formed in the surface to provide cooling channels and afterwards the article singulated into a plurality of finished articles.

Without being bound by theory, it is thought that by working the article whilst it is in the intermediate condition comprising permanent magnetic properties and a low fraction of the magnetocalorically active phase, a phase change which occurs at temperatures in the region of the magnetic phase transition temperature fails to occur during working and any tension which may be associated with the phase change is avoided. By avoiding tension during working due to a phase change, cracking or splitting of the article during working can be avoided.

Magnetocalorically active phases such as La(Fe_{1-a-b}SiₐCo_{b})₁₃ have been demonstrated to display a negative volume change at temperatures around the Curie temperature. Articles comprising these phases have been successfully worked using the methods described herein.

Manufacture of Articles Comprising at Least One magnetocalorically La(Si,Co,Fe)₁₃-Based Phase for Use in a Magnetic Heat Echanger

In an embodiment, articles comprising a magnetocalorically active phase of the La(Si,Co,Fe)₁₃ system in the form of plates with dimensions of 11.5 mm×5.8 mm by 0.6 mm were fabricated by providing an intermediate block comprising, in total, elements in amounts to form the desired magnetocalorically active phase and an Alpha-Fe content of at least 50%.

These intermediate blocks were worked by wire erosion cutting to form a plurality of plates of the desired size. These plates were then further heat treated to form the magnetocalorically active phase.

The intermediate blocks were fabricated using powder metallurgical techniques and a two stage heat treatment.

In a further embodiment, a first powder mixture, comprising 7.7 weight percent cobalt, 3.3 weight percent silicon, 18.7 weight percent lanthanum, balance iron was provided by milling the starting powders. This composition provides a magnetocalorically active phase with a T_{c} of around +29° C.

A first second powder mixture, comprising 9.7 weight percent cobalt, 3.2 weight percent silicon, 18.7 weight percent lanthanum, balanced iron was provided by milling the starting powders. This composition provides a magnetocalorically active phase with a T_{c} of around +59° C.

A third powder mixture was produced by mixing the first and second powder mixtures in a one-to-one ratio to provide a powder with a composition with which a magnetocalorically active phase with a T_{c} of +44° C. can be fabricated.

The three powder mixtures were pressed with a pressure of 4 tonnes/cm² to provide green bodies with dimensions of 26.5 mm×21.8 mm×14.5 mm.

Afterwards, the green bodies were given a two stage heat treatment to form workable intermediate blocks. In particular, the green bodies were heat treated at 1080° C. for 7 hours under vacuum and 1 hour under argon, cooled in one hour to 800° C. and held at 800° C. for 6 hours in argon and then cooled to room temperature in about an hour.

Without being bound by theory, the first dwell stage at the higher temperature is thought to promote liquid phase reaction sintering to produce a high density and to form the magnetocalorically active phase. The second dwell stage at the lower temperature is thought to decompose the magnetocalorically active phase and promote the formation of Alpha-Fe phases as well as La- and Si-rich phases.

The Alpha-Fe content of the blocks fabricated from the first (MPS-1044), second (MPS-1045) and third (MPS-1046) powder mixtures are summarised in Table 6. Each of the blocks had a density of around 7.25 g/cm³ and an α-Fe content of 60.3%, 57.8% and 50.6%, respectively.

TABLE 6
Density and α-Fe content of blocks 1 (MPS-1044),
2 (MPS-1045) and 3 (MPS-1046) in the workable condition

| | Density | α-Fe content |
|---|---|---|
| sample | (g/cm³) | (%) |
| MPS-1044 | 7.26 | 60.3 |
| MPS-1045 | 7.25 | 57.8 |
| MPS-1046 | 7.25 | 50.6 |

The blocks were then cut by wire erosion cutting to form a plurality of plates having dimensions of the 11.5 mm×5.8 mm×0.6 mm.

Samples of the singulated block were then heat treated at one of three temperatures; 1000° C., 1025° C. and 1050° C., for 4 hours under argon to form the magnetocalorically active phase. The entropy change and Curie temperature were measured to investigate the magnetocaloric properties and the Alpha-Fe content determined which gives an indication of the extent to which the reaction is complete. These results are summarised in Table 7. The Alpha-Fe content was reduced from over 50% in the intermediate samples to less than 7.2% for all of the heat treated samples.

TABLE 7
Mangetocaloric properties measured for blocks (MPS-1044),
2 (MPS-1045) and 3 (MPS-1046) after further annealing at
three different temperatures TH for 4 hours under argon.

| | | | ΔS′_{m · max} | | | | ΔS′_{m · max} |
|---|---|---|---|---|---|---|---|
| sam- | TH | Density | (J/ | Tₚₑₐₖ | ΔT_{whh} | WMFA | (kJ/ |
| ple | (° C.) | (g/cm³) | (kg · K) | (° C.) | (° C.) | (%) | (m³ · K) |
| MPS- | 1000 | 7.26 | 5.9 | 26.8 | 23.9 | 7.2 | 42.7 |
| 1044 | | | | | | | |
| MPS- | 1000 | 7.25 | 5.2 | 42.1 | 27.1 | 6.9 | 37.9 |
| 1045 | | | | | | | |
| MPS- | 1000 | 7.25 | 4.6 | 56.8 | 31.6 | 7.0 | 33.5 |
| 1046 | | | | | | | |
| MPS- | 1025 | 7.26 | 6.3 | 28.8 | 22.7 | 4.5 | 45.6 |
| 1044 | | | | | | | |
| MPS- | 1025 | 7.25 | 5.6 | 41.2 | 22.2 | 4.7 | 40.3 |
| 1045 | | | | | | | |
| MPS- | 1025 | 7.25 | 4.8 | 57.2 | 30.7 | 4.4 | 34.4 |
| 1046 | | | | | | | |
| MPS- | 1050 | 7.26 | 6.0 | 28.1 | 24.2 | 4.2 | 43.5 |
| 1044 | | | | | | | |
| MPS- | 1050 | 7.25 | 5.3 | 42.3 | 27.6 | 4.5 | 38.4 |
| 1045 | | | | | | | |
| MPS- | 1050 | 7.25 | 4.9 | 56.6 | 31.1 | 4.5 | 35.1 |
| 1046 | | | | | | | |

A further set of plates were heat treated at 1030±3° C. for 4 hours in argon and the results are summarised below.

Block 1 fabricated from the first powder mixture has a T_{c} of 28.7° C., an entropy change of 6 J/(kg·K) or 43.4 kJ/(m³·K) and an Alpha-Fe content of 5.0%.

Block 2 fabricated from the second powder mixture has a T_{c} of 43.0° C., an entropy change of 5.2 J/(kg·K) or 37.9 kJ/(m³·K) and an Alpha-Fe content of 5.0%.

Block 3 fabricated from the third powder mixture has a T_{c} of 57.9° C., an entropy change of 4.4 J/(kg·K) or 32.2 kJ/(m³·K) and an Alpha-Fe content of 7.4%.

Composition Range of the La(Fe,Si,Co)₁₃ System Exhibiting a Reversible Phase Transformation

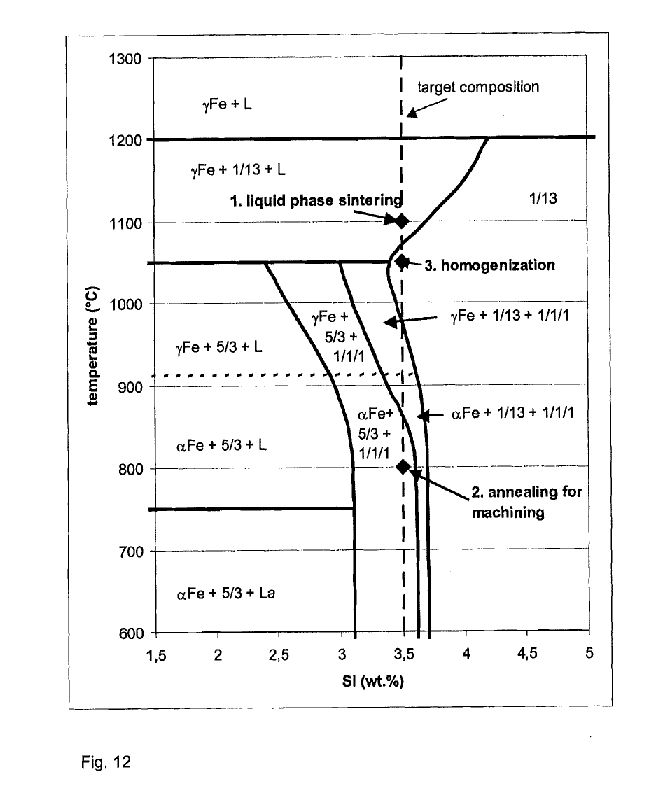

Without being bound by theory, the reversible phase transformation observed in the La(Fe,Si,Co)₁₃ system may be understood on the basis of the following description of the phase diagram. FIG. 12 illustrates a theoretical phase diagram illustrating the effect of silicon contents from 1.5 wt % to 5 wt % on phase formation at temperatures in the range of 600° C. to 1300° C. for a composition with 8 wt % Co at a ration of La:(Fe+Co+Si) of 1:13.

The target composition has a silicon content of 3.5 wt % and is indicated with dashed line 100. The magnetocalorically active phase is indicated as 1/13 (La₁: (Fe, Si, Co)₁₃) and is formed as a single phase at the right hand side of this portion of the phase diagram.

Taking a silicon content of the target composition and following the diagram for increasing temperature, it can be seen that for temperatures from 600° C. to around 850° C., a region comprising Alpha-Fe, 5/3 (La₅Si₃) and 1/1/1 (La₁(Fe,Co)₁Si₁) is stable. At temperatures from around 850° C. to around 975° C. a region comprising Gamma-Fe, 1/13 and 1/1/1 is stable. From temperatures of around 975° C. to around 1070° C. a region comprising a single 1/13 phase is stable. From temperatures from around 1070° C. to around 1200 a region comprising Gamma-Fe, 1/13 and liquid L is stable.

A method of fabricating an article with the target composition may include heating at a first temperature of 1100° C. which enables liquid phase sintering to occur as 1100° C. lies in the Gamma-Fe, 1/13 and liquid L region. The temperature may then be lowered to 800° C. which lies in the Alpha-Fe, 5/3 and 1/1/1 so that the magnetocalorically active 1/13 phase is decomposed. After this heat treatment the article may be reliably worked. After working, the article may be heat treated at a temperature of 1050° C. which lies in the single phase 1/13 region to reform the magnetocalorically active phase with a high 1/13 phase content.

In order to be able to move through these three regions of the phase diagram, the silicon content should lie within a predetermined region indicated by dashed lines 101 and 102. In particular, the lower limit of the silicon content is determined by the boundary between the single phase 1/13 region and the Gamma-Fe, 1/13 and 1/1/1 and Gamma-Fe 1/13 +L regions. The upper limit of the silicon content is determined by the boundary between the Alpha-Fe, 5/3 and 1/1/1 regions and the Alpha-Fe, 1/13 and 1/1/1 region.

The invention having been thus described with reference to certain specific embodiments and examples thereof, it will be understood that this is illustrative, and not limiting, of the appended claims.

1. A method of producing an article comprising at least one magnetocalorically active phase, comprising:
providing an intermediate article comprising, in total, elements in amounts capable of providing at least one (La₁₋ₐMₐ)(Fe_{1-b-c}T_{b}Y_{c})_{13-d}Xₑ phase and less than 5 Vol % impurities, wherein 0≦a≦0.9, 0≦b≦0.2, 0.05≦c≦0.2, −1≦d≦+1, 0≦e≦3, M is one or more of the elements Ce, Pr and Nd, T is one or more of the elements Co, Ni, Mn and Cr, Y is one or more of the elements Si, Al, As, Ga, Ge, Sn and Sb, and X is one or more of the elements H, B, C, N, Li and Be, wherein the intermediate article comprises a permanent magnet,
working the intermediate article by removing at least one portion of the intermediate article, and then
heat treating the intermediate article to produce a final product comprising at least one magnetocalorically active (La₁₋ₐMₐ)(Fe_{1-b-c}T_{b}Y_{c})_{13-d}Xₑ phase.

2. The method according to claim 1, wherein the intermediate article comprises an Alpha-Fe content of greater than 50 vol %.

3. The method according to claim 1, further comprising heat treating the intermediate article to produce an Alpha-Fe content of less than 5 vol %.

4. The method according to claim 3, wherein said producing the intermediate article comprises by heat treating a precursor article comprising at least one phase with a NaZn₁₃-type crystal structure.

5. The method according to claim 4, wherein said producing the precursor article comprises heat treating under conditions that produce at least one Alpha-Fe-type phase.

6. The method according to claim 5, wherein said heat treating comprises heat treating the precursor article under conditions that decompose the phase with the NaZn₁₃-type crystal structure and form at least one Alpha-Fe-type phase.

7. The method according to claim 6, wherein said heat treating comprises heat treating the precursor article under conditions that produce permanently magnetic inclusions in a non-magnetic matrix.

8. The method according to claim 7, wherein said heat treating comprises heat treating the precursor article to produce a permanently magnetic portion of at least 60 vol %.

9. The method according to claim 4, further comprising producing the precursor article by mixing powders that provide, in total, elements in amounts capable of providing at least one (La₁₋ₐMₐ)(Fe_{1-b-c}T_{b}Y_{c})_{13-d}Xₑ phase and sintering the powders at a temperature T1 to produce at least one phase with a NaZn₁₃-type crystal structure.

10. The method according to claim 9, further comprising heat treating the precursor article at a temperature T2 to form the intermediate article comprising at least one permanently magnetic phase, wherein T2<T1 after the heat treating at temperature T1.

11. The method according to claim 10, wherein T2 produces a decomposition of the phase with the NaZn₁₃-type crystal structure at T2.

12. The method according to claim 10, further comprising heat treating the intermediate article at a temperature T3 to produce a final product comprising at least one magnetocalorically active (La₁₋ₐMₐ)(Fe_{1-b-c}T_{b}Y_{c})_{13-d}Xₑ phase, wherein T3>T2.

13. The method according to claim 12, wherein T3<T1.

14. The method according to claim 13, wherein the precursor article comprises a composition that produces a reversible decomposition of the phase with the NaZn₁₃-type crystal structure at T2 and that produces a reformation of the NaZn₁₃-type crystal structure at T3.

15. The method according to claim 1, wherein the portion of the intermediate article is removed by machining.

16. The method according to claim 1, wherein the portion of the intermediate article is removed by mechanical grinding, mechanical polishing or chemical-mechanical polishing.

17. The method according to claim 1, wherein the portion of the intermediate article is removed by electric spark cutting or wire erosion cutting or laser cutting or laser drilling or water beam cutting.

18. The method according to one of claim 1, wherein by the removing a portion of the intermediate article comprises separating the intermediate article into two or more separate pieces.

19. The method according to claim 1, wherein the removing portion of the intermediate article comprises forming at least one channel in a surface of the article or at least one through-hole in the article.

20. An intermediate article for the production of an article comprising at least one magnetocalorically active phase, comprising, in total, elements in amounts capable of providing at least one (La₁₋ₐMₐ)(Fe_{1-b-c}T_{b}Y_{c})_{13-d}Xₑ phase and less than 5 Vol % impurities, wherein 0≦a≦0.9, 0≦b≦0.2, 0.05≦c≦0.2, −1≦d≦+1, 0≦e≦3, M is one or more of the elements Ce, Pr and Nd, T is one or more of the elements Co, Ni, Mn and Cr, Y is one or more of the elements Si, Al, As, Ga, Ge, Sn and Sb and X is one or more of the elements H, B, C, N, Li and Be, wherein the intermediate article comprises a permanent magnet.

21. The intermediate article according to claim 20, wherein the composition of the at least one (La₁₋ₐMₐ)(Fe_{1-b-c}T_{b}Y_{c})_{13-d}Xₑ phase exhibits a reversible phase decomposition reaction.

22. The intermediate article according to claim 21, wherein the composition of the at least one (La₁₋ₐMₐ)(Fe_{1-b-c}-T_{b}Y_{c})_{13-d}Xₑ phase exhibits a reversible phase decomposition reaction into at least one Alpha-Fe-based phase and La-rich and Si-rich phases.

23. The intermediate article according to claim 20, wherein the at least one (La₁₋ₐMₐ)(Fe_{1-b-c}T_{b}Y_{c})_{13-d}Xₑ phase is formable by liquid-phase sintering.

24. The intermediate article according to claim 21, wherein a=0, T is Co and Y is Si and e=0.

25. The intermediate article according to claim 24, wherein 0<b≦0.075 and 0.05<c≦0.1.

26. The intermediate article according to claim 25, wherein the intermediate article comprises at least one Alpha-Fe-type phase.

27. The intermediate article according to claim 26, wherein the intermediate article comprises greater than 60 vol % of one or more Alpha-Fe-type phases.

28. The intermediate article according to claim 26, wherein the Alpha-Fe-type phase further comprises Co and Si.

29. The intermediate article according to claim 26, wherein the intermediate article further comprises La-rich and Si-rich phases.

30. The intermediate article according to claim 21, wherein the intermediate article comprises a non-magnetic matrix and a plurality of permanently magnetic inclusions distributed in the non-magnetic matrix.

31. The intermediate article according to claim 30, wherein the permanently magnetic inclusions comprise an Alpha-Fe-type phase.

32. The intermediate article according to claim 31, wherein the article has Bᵣ>0.35T and H_{cJ}>80 Oe.

33. The intermediate article according to claim 32, wherein the article has Bₛ>1.0 T.

34. The intermediate article according to claim 33, which exhibits a temperature dependent transition in length or volume at temperatures around the magnetic phase transition temperature T_{c}, wherein (L_{10%}-L_{90%})×100/L<0.1.

35. An article comprising at least one magnetocalorically active LaFe₁₃-based phase having a magnetic phase transition T_{c} and less than 5 Vol % impurities, wherein the composition of the at least one LaFe₁₃-based phase exhibits a reversible phase decomposition reaction.

36. The article according to claim 35, wherein the composition of the at least one LaFe₁₃-based phase exhibits a reversible phase decomposition reaction into at least one Alpha-Fe-based phase and La-rich and Si-rich phases.

37. The article according to claim 35 characterized in that the LaFe₁₃-based phase is (La₁₋ₐMₐ)(Fe_{1-b-c}T_{b}Y_{c})_{13-d}Xₑ wherein 0≦a≦0.9, 0≦b≦0.2, 0.05≦c≦0.2, −1≦d≦+1, 0≦e≦3, M is one or more of the elements Ce, Pr and Nd, T is one or more of the elements Co, Ni, Mn and Cr, Y is one or more of the elements Si, Al, As, Ga, Ge, Sn and Sb, and X is one or more of the elements H, B, C, N, Li and Be.

38. The article according to claim 37, wherein the at least one (La₁₋ₐMₐ)(Fe_{1-b-c}T_{b}Y_{c})_{13-d}Xₑ phase is formable by liquid-phase sintering.

39. The article according to claim 37, wherein at least one (La₁₋ₐMₐ)(Fe_{1-b-c}T_{b}Y_{c})_{13-d}Xₑ phase comprises a silicon content such that the reversible phase decomposition reaction provides at least one Alpha-Fe-based phase and La-rich and Si-rich phases.

40. The article according to claim 37, wherein a=0, T is Co and Y is Si and e=0.

41. The article according to claim 40, wherein 0<b≦0.075 and 0.05<c≦0.1.

42. The article according to claim 35, which exhibits a temperature dependent transition in length or volume at temperatures around the magnetic phase transition temperature T_{c}, wherein (L_{10%}-L_{90%})×100/L>0.2.

43. The article according to claim 35, wherein the magnetocalorically active phase exhibits a magnetic phase transition temperature and exhibits a temperature dependent transition in length or volume at temperatures near the magnetic phase transition temperature.

44. The article according to claim 35, wherein the magnetocalorically active phase exhibits a negative linear thermal expansion for increasing temperatures.

45. The article according to 35, wherein the magnetocalorically active phase comprises a NaZn₁₃-type structure.

46. The article according to claim 35, comprising at least two magnetocalorically active phases each having a different magnetic phase transition temperature T_{c}.

47. An article comprising at least one magnetocalorically active phase having a magnetic phase transition temperature T_{c} manufactured using the method of claim 1.

48. (canceled)

49. A magnetic heat exchanger comprising the article of claim 35.
